(19) United States
(12) Patent Application Publication
(10) Pub. No.: US 2021/0270270 A1
(43) Pub. Date: Sep. 2, 2021

(54) DUAL OR MULTI-SHAFT VACUUM PUMP

(71) Applicant: LEYBOLD GMBH, Koln (DE)

(72) Inventors: Dirk Schiller, Hürth (DE); Wolfgang Giebmanns, Erftstadt (DE); Klauspeter Schlick, Köln (DE); Thomas Dreifert, Kerpen (DE)

(73) Assignee: LEYBOLD GMBH, Koln (DE)

(21) Appl. No.: 17/256,449

(22) PCT Filed: Jun. 25, 2019
(86) PCT No.: PCT/EP2019/066874

§ 371 Date: Dec. 28, 2020

(30) Foreign Application Priority Data
Jul. 3, 2018 (DE) 10 2018 210 922.2

(51) Int. Cl. F04C 28/28; F04C 23/02; F04C 25/02; F04C 29/00; F04C 18/16

(52) U.S. Cl. CPC F04C 28/28; F04C 23/02; F04C 25/02; F04C 29/005; F04C 2270/16; F04C 2240/60; F04C 2240/81; F04C 2270/12; F04C 2220/10; F04C 18/16

(57) ABSTRACT

Dual- or multi-shaft vacuum pump comprising an engine, a first shaft and at least one second shaft, wherein the first shaft and the second shaft are synchronously driven by the motor via a common drive belt. The first shaft has a pumping element and the second shaft likewise has a pumping element which cooperates with the pumping element of the first shaft in order to convey a gaseous medium from an inlet to an outlet. The first shaft has a first emergency running gear and the second shaft likewise has a second emergency running gear which meshes with the first emergency running gear.

### BACKGROUND

### 1. Field of the Disclosure

The present disclosure relates to a dual- or multi-shaft vacuum pump for generating a vacuum.

### 2. Discussion of the Background Art

Known dual-shaft vacuum pumps comprise a housing and a motor. A first shaft carrying a first pumping element and a second shaft carrying a second pumping element are arranged in the housing. The shafts are rotated by means of the motor. The two pumping elements cooperate with each other such that a gaseous medium is conveyed from an inlet of the housing to an outlet.

In order to effectively generate a vacuum by the dual-shaft vacuum pump, the pumping elements may only have a small distance and thus also only a small circumferential backlash. However, contact between the pump elements must be avoided. For this purpose, it is required that the shafts are driven synchronously. In case of a loss of said synchronization, the pumping elements contact each other which would result in a severe damage to or even destruction of the vacuum pump.

Usually, synchronous driving of the dual-shaft is performed by a suitable transmission, in particular by gears which are meshed with each other. A gear-type transmission requires a continuous lubricant supply which is very complex to realize in terms of construction within a dry-compressing vacuum pump. Even for shaft seals with a highly complex structure, the lubricant cannot be kept away completely from the suction chamber of the pump, which results in undesired interactions with pumped substances. Furthermore, it is thus necessary to monitor the presence of lubricants or to exchange lubricants, respectively.

An object of the present disclosure is to provide a dry-compressing dual or multi-shaft vacuum pump which operates completely without oil supply.

### SUMMARY

The dual- or multi-shaft vacuum pump according to the disclosure comprises a motor as well as a first shaft an at least one second shaft. If only a first shaft and a second shaft are provided, it is a dual-shaft vacuum pump. In case of more than two shafts, it is a multi-shaft vacuum pump, wherein the principle of the present disclosure is not limited to the number of provided shafts. According to the disclosure, the first shaft and the second shaft are synchronously driven or rotated, respectively, by the motor via a common drive belt. Here, the drive belt particularly is a toothed belt. Moreover, the first shaft comprises a pumping element and the second shaft likewise comprises a pumping element. The pumping elements of the first shaft and the pumping elements of the second shaft cooperate with each other in order to convey a gaseous medium from an inlet to an outlet. Due to the provision a drive belt for the synchronization of the provided shafts, the shafts do not contact each other in normal operation. This reduces the occurrence of vibrations, resulting in a particularly quiet and low-maintenance pump. It is also not required to provide a lubricant or to monitor the lubricant, respectively.

According to the disclosure, the first shaft has a first emergency running gear. Likewise, the second shaft has a second emergency running gear which meshes with the first second emergency running gear. If the drive belt fails, the first emergency running gear and the second emergency running gear prevent that the pumping elements of the first shaft and of the second shaft contact each other. If the drive belt fails, the provided emergency running gears thus carry out the required synchronization of the shafts in order to prevent that the pumping elements contact each other and are thus damaged. A failure of the drive belt may occur, for example, through tearing or, if the drive belt is designed as a toothed belt, through loss of teeth or elongation of the drive belt, for example due to wear. Since drive belts are inherently subjected to a certain wear in the course of their lifetime, a secure operation of a dual- or multi-shaft vacuum pump, in which the synchronization of the shafts is performed by means of a drive belt, is only possible by providing emergency running gears which ensure the required synchronization if the drive belt fails.

Preferably, the emergency running gears do not contact each other in faultless operation or in normal operation, respectively. Thus, the provided shafts can be operated without contacting each other. Only if the drive belt fails in the event of a failure, for example tearing, wear, elongation of drive belt or loss of teeth, the emergency running gears contact each other in order to ensure the synchronization of the waves. Since the emergency running gears do not contact each other in normal operation, providing emergency running gears does not cause disadvantageous effects such as in known dual- or multi-shaft vacuum pumps in which the shafts are synchronized with each other by means of a transmission.

Preferably, the emergency running gears have a circumferential backlash to each other which is smaller than the circumferential backlash of the pumping elements to each other. In particular, the circumferential backlash of the emergency running gears is 75% and preferably 50% of the circumferential backlash of the pumping elements to each other. It is thus ensured that prior to a contact of the pumping elements, the emergency running gears come into contact in order to thus prevent a damage to the pumping elements.

In a particularly preferred embodiment, the emergency running gears are configured such that the two gears have a material combination of metal and plastic. It is thus possible to meet the very high requirements concerning the angular conformality of the transmission in screw vacuum pumps. In particular, occasional contact of the gears can be accepted even if the belt is intact. This works particularly well with a material combination of metal and plastic, since with such a material combination such contact at particularly high speeds is permissible even without providing a lubricant.

Preferably, the emergency running gears have a circumferential backlash to each other which is greater than the circumferential backlash of the drive belt. It is thus ensured that the emergency running gears are not in contact with each other in normal operation. The synchronization is thus performed in normal operation via the drive belt. In normal operation, the circumferential backlash of the drive belt is thus smaller than the circumferential backlash of the emergency running gears. If the circumferential backlash of the drive belt increases, for example through loos of teeth or wear, such that the synchronization of the pumping elements gets lost, the synchronization of the pumping elements is ensured through the emergency running gears.

Preferably, a sensor for detecting a contact of the emergency running gears is provided. In particular, the sensor is connected with an evaluation device, wherein the evaluation device is configured such that a warning signal is provided when a contact of the emergency running gears is determined. Since the emergency running gears only come into contact with each other in the event of a failure of the drive belt, the contact of the emergency running gears can be used as an indication of a fault. As soon as the emergency running gears come into contact, the dual- or multi-shaft vacuum pump is no longer in normal operation. The warning signal can then be used to switch off the dual- or multi-shaft vacuum pump in order to prevent damage to the pumping elements and, alternatively or additionally, a maintenance or maintenance request can be caused when the emergency gears contact each other.

Preferably, the sensor is a vibration sensor which detects the vibration generated by the contact of the emergency running gears. If the emergency running gears come into contact with each other, vibrations are generated which can then be detected by the sensor. Thus, a contact of the emergency running gears can be easily detected by means of the detected vibration.

Preferably, the tooth count of the emergency running gears is clearly selected so that a unique tooth meshing frequency is generated when the emergency running gears contact each other. Thus, by means of the unique tooth engagement frequency, the contact of the emergency running gears can be clearly identified by a sensor and is thus distinguishable from further vibrations of the dual- or multi-shaft vacuum pump.

Preferably, the emergency running gears are made of stainless steel, galvanized steel, plastic or hard-coated aluminum.

Preferably, the vacuum pump is a claw pump, screw pump or single- or multi-stage Roots pump.

Preferably, a plurality of shafts is provided, wherein each shaft comprises an emergency running gear.

### BRIEF DESCRIPTION OF THE DRAWINGS

In the following, the disclosure is described in more detail by means of preferred embodiments with reference to the accompanying drawings, in which

FIG. 1 shows a dual-shaft pump according to the disclosure, which is designed as a screw pump,

FIG. 2 shows a detailed view of the emergency running gears of the dual-shaft vacuum pump shown in FIG. 1 according to the disclosure, and

FIG. 3 shows a detailed view of the emergency running gears of FIG. 2.

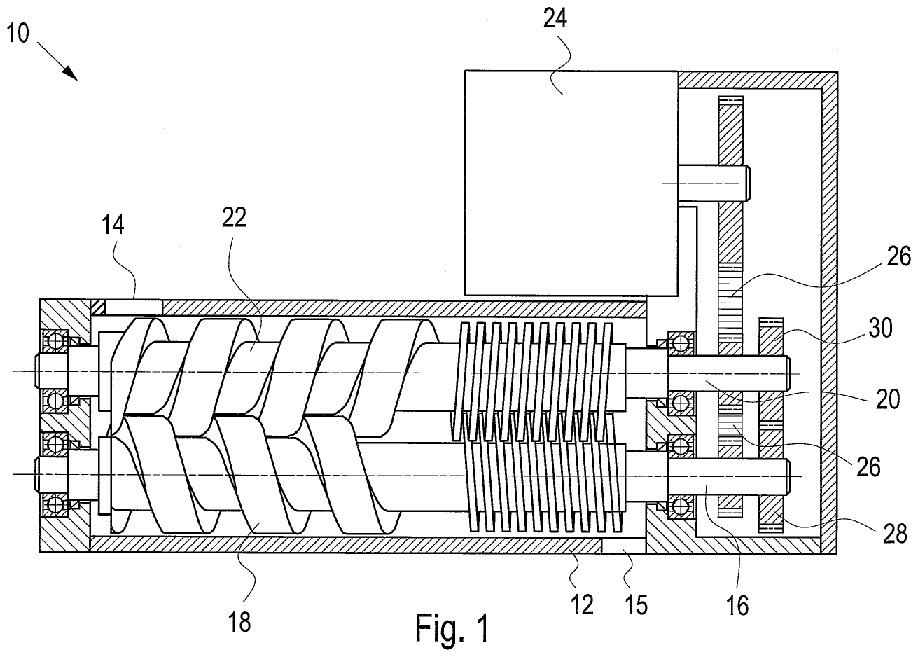

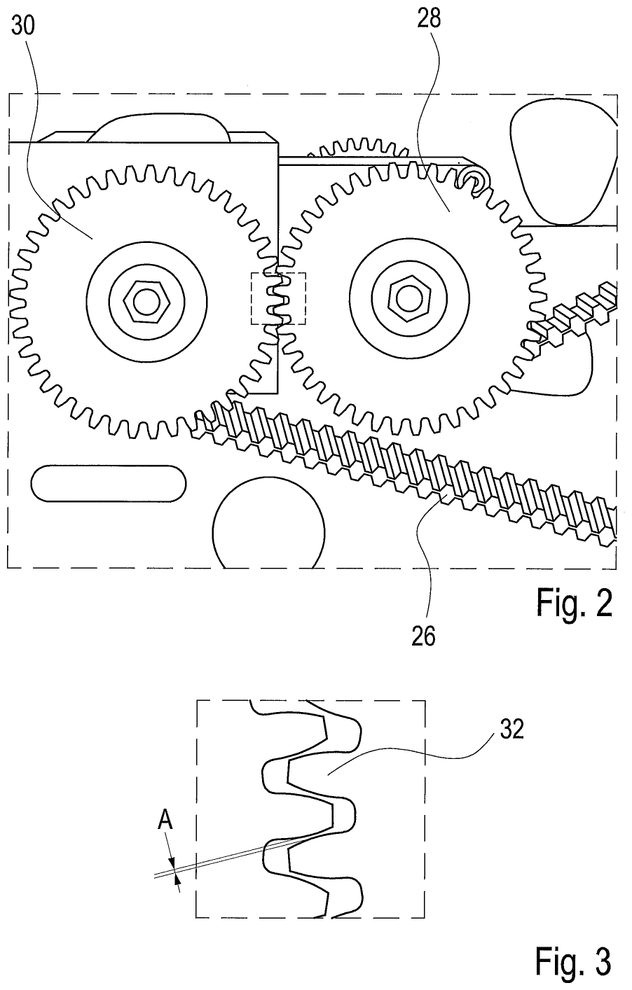

### DETAILED DESCRIPTION OF THE PREFERRED EMBODIMENT

The vacuum pump 10 according to the disclosure, which is designed as a screw pump, comprises a housing 12 having an inlet 14 and an outlet 15. A first shaft 16 is arranged in housing 12 with a first pumping element 18 being designed as a screw body in the illustrated example. Furthermore, a second shaft 20 is arranged in housing 12 with a second pumping body 22 also designed as a screw body. The first pumping element 18 and the second pumping element 22 are meshed with each other. Moreover, a motor 24 is provided which can be configured as an electric motor. By means of a drive belt 26, the first shaft 16 and the second shaft 20 are rotated or driven, respectively, by motor 24. The rotation of the shafts 16, 20 is performed in opposite direction such that a gaseous medium is conveyed from inlet 14 to the outlet. In order to generate an effective vacuum, it is required that the distance between the pumping elements 18, 22 is very small. At the same time, the pumping elements 18, 22 may not contact each other since this would result in a severe damage due to the opposite direction of rotation. The synchronization of the pumping elements 18, 22 or of the shafts 16, 20, respectively, is ensured via the drive belt 26 in normal operation. For this purpose, the circumferential backlash of the drive belt 26 is smaller than the circumferential backlash of the pumping elements 18, 22 so that a contact of the pumping elements 18, 22 is just prevented.

If an elongation of the drive arm 26, for example through wear, a loss of teeth or a tearing of the drive belt 26 occurs, it further needs to be ensured that the pumping elements 18, 22 do not come into contact with each other, which would result in a severe damage to the pumping elements 18, 22. For this purpose, the first shaft 16 has a first emergency running gear 28. Furthermore, the second shaft 20 has a second emergency running gear 30 which meshes with the first emergency running gear 28. Here, however, the emergency running gears 28, 30 do not contact each other in normal operation. Only in the event of a failure of the drive belt 26, if the synchronization of the shafts 16, 20 is no longer ensured by the drive belt 26, the emergency running gears 28, 30 come into contact with each other so that the synchronization of the shafts 16, 20 is further ensured by the emergency running gears 28, 30. Here, the emergency running gears 28, 30 have a circumferential backlash which is smaller than the circumferential backlash of the pumping elements 18, 22 to each other. It is thus ensured that the pumping elements 18, 22 further remain without contact, even upon contact of the emergency running gears 28, 30. As shown in FIG. 3, a distance A between the teeth 32 of the emergency running gears 28, 30 ensures that the emergency running gears 28, 30 remain without contact in normal operation. However, the distance A of the teeth 32 of the emergency running gears 28, 30 causes a circumferential backlash of the emergency running gears 28, 30. The distance A is selected such that the resulting circumferential backlash of the emergency running gears 28, 30 is just smaller than the circumferential backlash of the pumping elements 18, 22. On the other hand, however, the circumferential backlash of the emergency running gears 28, 30 is greater than the circumferential backlash of the drive belt 26 in normal operation. It is thus ensured that in normal operation the synchronization of the shafts 16, 20 is performed via the toothed belt 26 and that the emergency running gears 28, 30 remain without contact.

Thus, a dual- or multi-shaft vacuum pump is provided in which the synchronization of the shafts 16, 18 can be performed by means of a drive belt 26. Here, the synchronization of the shafts 16, 18 is ensured by the emergency running gears 28, 30 which just take over the synchronization of the shafts 16, 18 in the event of a failure of the drive belt 26. Thus, a safe operation of the dual- or multi-shaft vacuum pump is guaranteed. However, since in normal operation the emergency running gears 28, 30 remain just without contact, the provision of the emergency running gears 28, 30 does not require a lubricant supply.

What is claimed is:

1. A dual- or multi-shaft vacuum pump, comprising
a motor,
a first shaft and at least one second shaft, wherein the first shaft and the second shaft are synchronously driven by the motor via a common drive belt,
wherein the first shaft has a pumping element and the second shaft has a pumping element which cooperates with the pumping element of the first shaft in order to convey a gaseous medium from an inlet to an outlet,
wherein the first shaft has a first emergency running gear and the second shaft has a second emergency running gear which meshes with the first emergency running gear-.

2. The dual- or multi-shaft vacuum pump according to claim 1, wherein there in no contact of the emergency running gears in normal operation.

3. The dual- or multi-shaft vacuum pump according to claim 1, wherein the emergency running gears have a circumferential backlash to each other which is smaller than the circumferential backlash of the pumping elements to each other and which is between about 50% to about 75% of the circumferential backlash of the pumping elements.

4. The dual- or multi-shaft vacuum pump according to claim 1, wherein the emergency running gears have a circumferential backlash to each other which is greater than the circumferential backlash of the drive belt.

5. The dual- or multi-shaft vacuum pump according to claim 1, further comprising a sensor for detecting a contact of the emergency running gears.

6. The dual- or multi-shaft vacuum pump according to claim 5, wherein the sensor is a vibration sensor which detects the vibration generated by the contact of the emergency running gears.

7. The dual- or multi-shaft vacuum pump according to claim 6, wherein the tooth count of the emergency running gears is clearly selected so that unique tooth meshing frequency is generated.

8. The dual- or multi-shaft vacuum pump according to claim 1, wherein the emergency running gears are made of at least one material selected from the group consisting of: stainless steel, galvanized steel, plastic and hard-coated aluminum.

9. The dual- or multi-shaft vacuum pump according to claim 1, wherein the vacuum pump is a claw pump, screw pump or single- or multi-stage Roots pump.

10. The dual- or multi-shaft vacuum pump according to claim 1, further comprising a plurality of shafts, wherein each said shaft has an emergency running gear.

11. The dual- or multi-shaft vacuum pump according to claim 1, wherein said common drive belt is a toothed belt.
